(19) United States
(12) Patent Application Publication
(10) Pub. No.: US 2020/0085179 A1
(43) Pub. Date: Mar. 19, 2020

(54) Hand Sponge For Styling Facial Hair

(71) Applicant: David Kweon, Los Angeles, CA (US)

(72) Inventor: David Kweon, Los Angeles, CA (US)

(21) Appl. No.: 16/136,186

(22) Filed: Sep. 19, 2018

(51) Int. Cl. A46B 5/04; A45D 19/02; A61Q 5/06

(52) U.S. Cl. CPC A46B 5/04; A47K 7/02; A61Q 5/06; A45D 19/02

(57) ABSTRACT

A hand sponge for styling facial hair includes a glove body having a main portion and five finger portions, a backside of the glove having a substantially bottom surface made of sponge which has rough thickness, and the sponge of the backside of the glove including a plurality of spaced-apart holes and a plurality of bumps.

### CROSS REFERENCE TO RELATED APPLICATIONS

NOT APPLICABLE

### FIELD OF INVENTION

The invention relates to a hand sponge for styling facial hair, in general, to hair care accessories and, more specifically, to devices for shaping and styling facial hair(beard, full beard, moustache, and sideburns).

### BACKGROUND OF INVENTION

The styling of beards, mustaches, side burns, and other areas of hair growth is important for maintaining an appropriate personal appearance. Men often wear mustaches that descend downwardly from the corners of the lips to merge at an acute angle with a beard running along the cheekbone. Styling into the restricted space within this acute angle is difficult. Also a beard can run along the chin, but otherwise leave the region under the lower lip hairless except for a vertical branch that runs upwardly toward the lower lip. Again, styling the relatively small region on either side of this vertical the branch can be difficult.

As a result, there is a need in the art for a hair shaping and styling device of use thereof. A wide variety of hairstyling devices and products continue to be created with the individual user in mind.

### SUMMARY OF INVENTION

The present invention related to a hand sponge for styling facial hair includes a glove body having a palm portion and five finger portion, a backside of the glove having a substantially bottom surface made of sponge which has rough thickness and the sponge of the backside of the glove including a plurality of spaced-apart holes and a plurality of bumps.

It is an object of the invention to provide a styling and shaping glove for facial hair to place the hand sponge glove to user's facial hair to achieve their desired looked.

It is another object to provide a styling and shaping mitten for facial hair.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a front view of a hand sponge in a form of a glove;

FIG. 2A illustrates a backside view of the glove with sponge in accordance with the principles of the present invention;

FIG. 2B illustrate an enlarged view of an area on the backside view of the glove showing three holes thereof;

FIG. 3 illustrates a perspective view of side view of the glove with a sponge;

FIG. 4 illustrates a perspective view of top view of the glove with the sponge;

FIG. 5 illustrates a perspective view of bottom view of the glove with the sponge;

FIG. 6 illustrates a front view of a hand sponge in a form of a mitten;

FIG. 7A illustrates a backside view of the mitten;

FIG. 7B illustrate an enlarged view of an area on the backside view of the mitten showing three holes thereof;

FIG. 8 illustrates a perspective view of side view of the mitten with a sponge;

FIG. 9 illustrates a perspective view of top view Of the mitten with the sponge;

FIG. 10 illustrates a perspective view of bottom view of the mitten with the sponge.

### DETAILED DESCRIPTION EMBODIMENTS OF INVENTION

Reference will now be made in detail to the preferred embodiments of the present invention, examples of which are illustrated in the accompanying drawings, which from a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

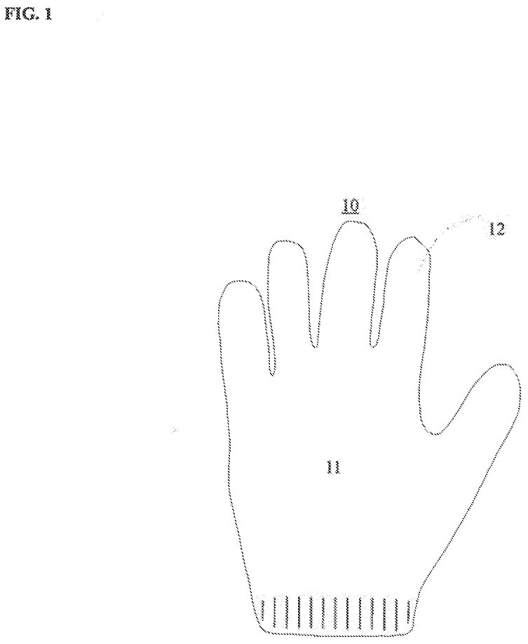

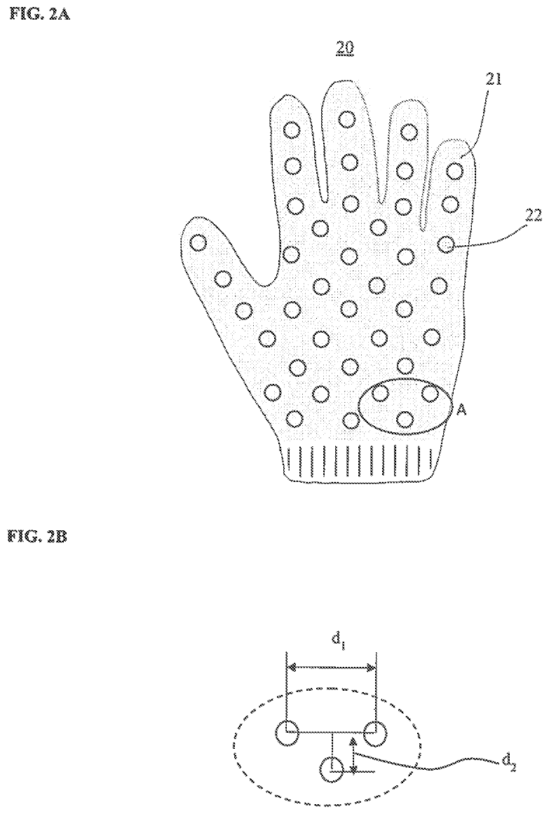

FIG. 1 is a front view of a first embodiment of a present invention, while FIG. 2A is a backside view of the first embodiment of the invention.

The hand sponge for styling facial hair 10 may be seen to include a palm portion 11 and a separate finger portion 12 which the user's hand may be fitted, as well five fingers. The backside view of the hand sponge for styling facial hair 20 includes a substantially bottom surface 21 made of sponge. The sponge of the backside of the glove including a plurality of spaced-apart holes 22. Rub with the plurality of spaced-apart holes 22 in circular or in a back and forth motion with optimal pressure help style which is user would like to make. The user can use oil, pomade, and other products to style enhance their look. The facial hair includes beard, full beard, moustache, and side burn.

FIG. 2B, an enlarged view of an area A on the backside view of the hand sponge showing three holes having a distances d₁ and d₂. The distance d₁ is between centers of adjacent of the plurality of spaced-apart holes in the palm portion of the hand sponge 11 (FIG. 1). A range of the distance d₁ is between 2 centimeters and 3 centimeters. The distance d₂ is between centers of one of lower line hole and middle of the centers of adjacent ones of the plurality of spaced-apart holes in the palm portion of the hand sponge 11 (FIG. 1). A range of the distance d₂ is between 1 centimeter and 2 centimeters.

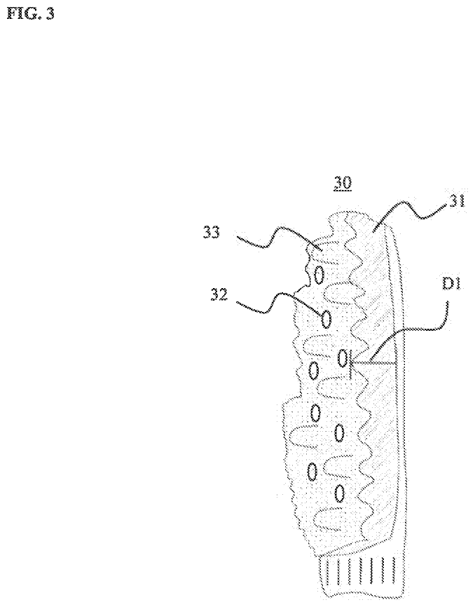

FIG. 3 is a side view of the hand sponge for styling facial hair 30 includes the bottom surface 31 made of the sponge. The sponge of the hand sponge includes a plurality of spaced-apart holes 32 and a plurality of bumps 33. Each of the plurality of holes 32 is spaced out with the plurality of bumps 33. The sponge has rough thickness D1 because of the plurality of bumps 33.

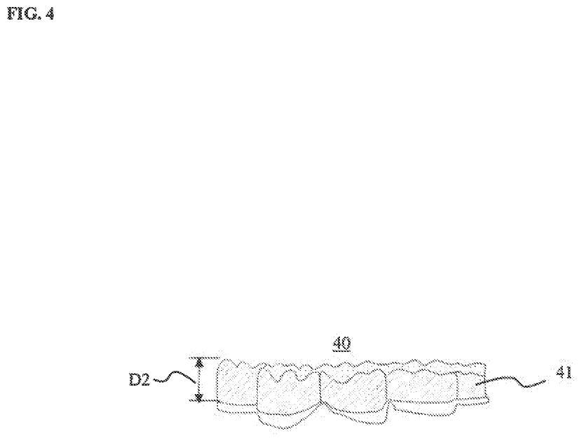

FIG. 4 is a top view of the hand sponge of the invention. A rough thickness D2 of the sponge 41 of the hand sponge 40 may be seen along with a thumb and small fingers. The rough thickness D2 is not constant.

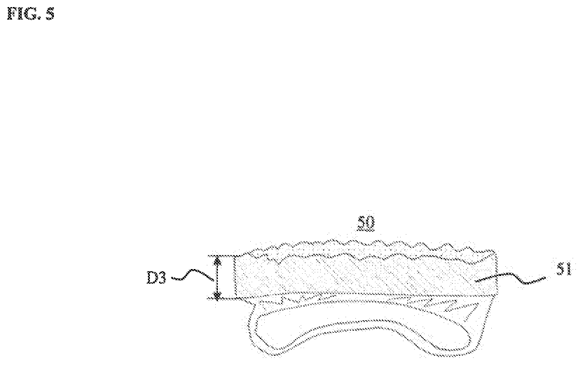

FIG. 5 is a bottom view of the hand sponge of the invention. A rough thickness D3 of the sponge 51 of the hand sponge 50 may be seen along with an opening of the glove. The rough thickness D3 is not constant.

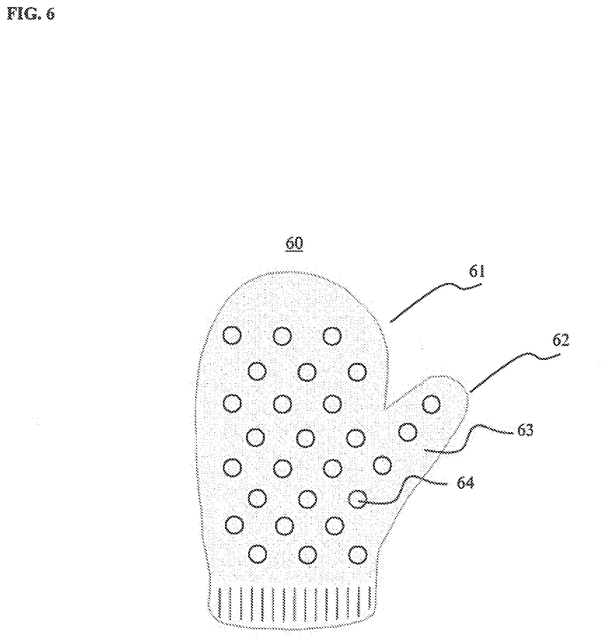

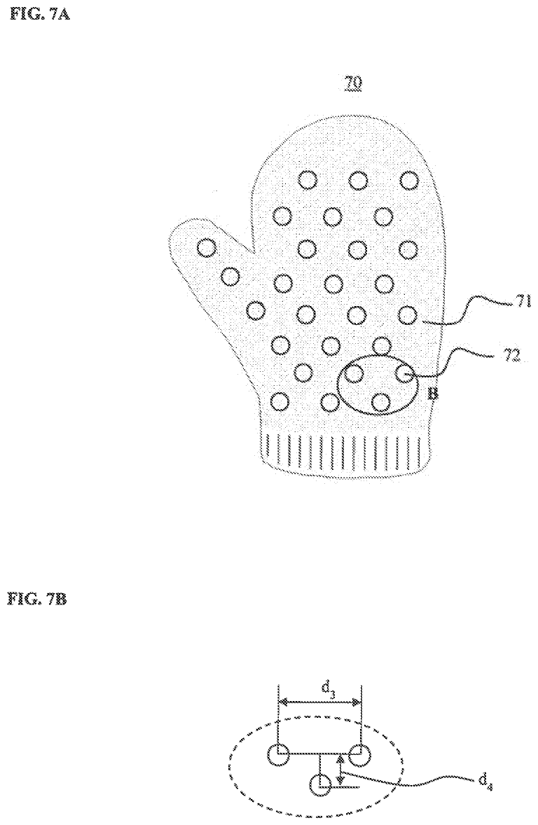

FIG. 6 is a front view of a second embodiment of the invention, while FIG. 7A is a backside view of the second embodiment of the invention.

A hand sponge for styling facial hair 60 may be seen to include the mitten body having a main pocket 61 and a separate thumb pocket 62. The front of the hand sponge 60 and the backside of the hand sponge 70 includes a substantially top surface 63 and a bottom surface 71. Both the top surface and the bottom surface are composed of sponge. Both sides sponge of mitten including a plurality of spaced-apart holes 64, 72. Rub with the plurality of spaced-apart holes 64, 72 in circular or in a back and forth motion with optimal pressure help style which is user would like to make. The user can use oil, pomade, and other products to style enhance their look. The facial hair includes beard, full beard, moustache, and side burns.

FIG. 7B, an enlarged view of an area B on the backside view of mitten showing three holes having a distances d₃ and d₄. The distance d is between centers of adjacent of the plurality of spaced-apart holes in the main pocket of the hand sponge 61(FIG. 6). A range of the distance d₃ is between 2 centimeters and 3 centimeters. The distance d₄ is between centers of one of lower line hole and middle of the centers of adjacent ones of the plurality of spaced-apart holes in the main pocket of the hand sponge 61(FIG. 6). A range of the distance d₄ is between 1 centimeter and 2 centimeters.

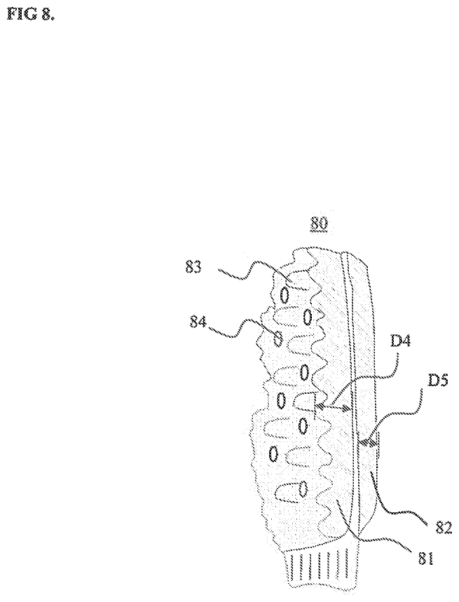

FIG. 8 is a side view of the hand sponge for styling facial hair 80 includes the top surface 81 attached the front the mitten and the bottom surface 82 attached the backside the mitten. Both of surfaces are made of the sponge. The sponge has a rough thickness D4 because of the plurality of bumps on the sponge and the sponge has a rough thickness D5 because of the plurality of bumps on the sponge. The rough thickness D4 and D5 are not constant.

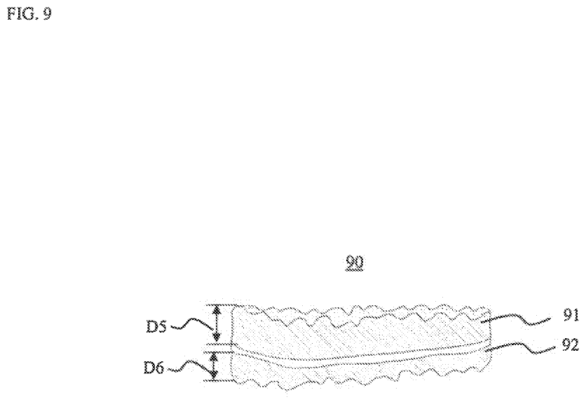

FIG. 9 is a top view of the hand sponge 90 of the invention. A rough thickness D5 of the hand sponge 91 and a rough thickness D6 of the hand sponge 92 may be seen along with a thumb pocket and main pocket. Both of the rough thicknesses are not constant.

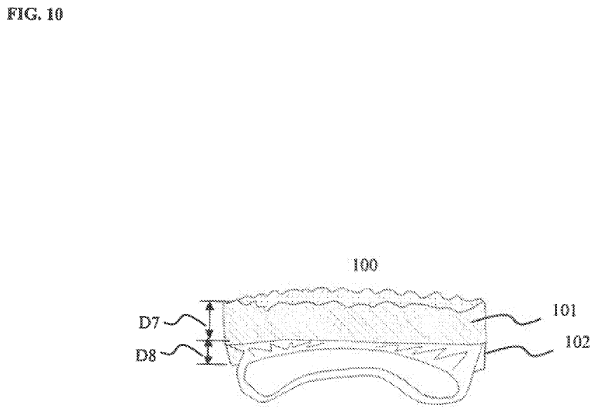

FIG. 10 is a bottom view of the hand sponge 100 of the invention. A rough thickness D7 of the hand sponge 101 and a rough thickness D8 of the hand sponge 102 may be seen along with an opening of the glove. Both of the rough thicknesses are not constant.

The invention claimed is:

1. A hand sponge for styling facial hair comprising:
a glove body having a palm portion and five finger portions;
a backside of the glove having a substantially bottom surface made of sponge which has rough thickness; and
the sponge of the backside of the glove including a plurality of spaced-apart holes and a plurality of bumps.

2. The hand sponge for styling facial hair in claim 1 wherein a range of distance between the centers of adjacent of the plurality of spaced-apart holes on the palm portion of the hand sponge being between 2 centimeters and 3 centimeters.

3. The hand sponge for styling facial hair in claim 2 wherein a range of distance between the centers of one of lower line hole and middle of the centers of adjacent ones of the plurality of spaced-apart holes on the palm portion of the hand sponge being between 1 centimeter and 2 centimeters.

4. The hand sponge for styling facial hair in claim 1 wherein adjacent holes of the plurality of spaced-apart-holes on the palm portion of the hand sponge are equally spaced apart by same distance.

5. The hand sponge for styling facial hair in claim 4 wherein each of the plurality of spaced-apart holes has a range of diameter being between 0.9 centimeters and 1.2 centimeters.

6. A hand sponge for styling facial hair comprising:
a mitten body having a main pocket and a separate thumb pocket;
a backside of the mitten having a substantially bottom surface made of sponge which has rough thickness; and
the sponge of the backside of the mitten including a plurality of spaced-apart holes and a plurality of bumps.

7. The hand sponge for styling facial hair in claim 5 wherein a front of the mitten having a substantially top surface made of sponge which is same material with the substantially bottom surface.

8. The hand sponge for styling facial hair in claim 6 wherein a range of distance between the centers of adjacent of the plurality of spaced-apart holes on the main pocket of the hand sponge being between 2 centimeters and 3 centimeters.

9. The hand sponge for styling facial hair in claim 7 wherein a range of distance between the centers of one of lower line hole and middle of the centers of adjacent ones of the plurality of spaced-apart holes on the main pocket of the hand sponge being between 1 centimeter and 2 centimeters.

10. The hand sponge for styling facial hair in claim 1 wherein adjacent holes of the plurality of spaced-apart-holes on the main pocket of the hand sponge are equally spaced apart by same distance.

11. The hand sponge for styling facial hair in claim 4 wherein each of the plurality of spaced-apart holes has a range of diameter being between 0.9 centimeters and 1.2 centimeters.
